(19) United States
(12) Patent Application Publication
(10) Pub. No.: US 2025/0240757 A1
(43) Pub. Date: Jul. 24, 2025

(54) CHANNEL STATE INFORMATION BASED LOCALIZATION

(71) Applicant: Samsung Electronics Co., Ltd., Suwon-si (KR)

(72) Inventors: Viet Nguyen, Frisco, TX (US); Guanbo Chen, Plano, TX (US); Yuming Zhu, Plano, TX (US)

(21) Appl. No.: 19/014,518

(22) Filed: Jan. 9, 2025

Related U.S. Application Data
(60) Provisional application No. 63/624,177, filed on Jan. 23, 2024.
(60) Provisional application No. 63/713,983, filed on Oct. 30, 2024.

(51) Int. Cl. H04W 64/00; H04B 7/06; H04L 41/16

(52) U.S. Cl. CPC H04W 64/00; H04B 7/0626; H04L 41/16

(57) ABSTRACT

Embodiments in accordance with this disclosure provide methods to compute a distance metric between two wireless data samples, including using a time reversal resonance index (TRRI) or deep metric learning, including different input shaping methods for channel state information or channel impulse response data to be used as inputs to a deep learning model.

### CROSS-REFERENCE TO RELATED APPLICATION(S)

This application claims the benefit of priority from U.S. Provisional Application No. 63/624,177, entitled “WIFI CSI-BASED LOCALIZATION AND PHYSICAL CONTEXT AWARENESS” filed Jan. 23, 2024; and U.S. Provisional Application No. 63/713,983, entitled “WIFI CSI-BASED LOCALIZATION AND PHYSICAL CONTEXT AWARENESS” filed Oct. 30, 2024, all of which are incorporated herein by reference in their entireties.

### TECHNICAL FIELD

This disclosure relates generally to a wireless communication system, and more particularly to, for example, but not limited to, channel state information (CSI) based localization in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network, comprising: a memory; and a processor coupled to the memory. The processor is configured to obtain, from one or more access points (APs), channel state information associated with two or more data samples as an input. The processor is configured to compute a distance metric using at least one of a time reversal resonance index or a deep metric learning using the input, wherein the distance metric is proportional to a true distance between two or more spatial points corresponding to the two or more data samples.

In some embodiments, the processor is further configured to use magnitude of the channel state information as the input.

In some embodiments, the time reversal resonance index is used to determine positions from which the channel state information originated from.

In some embodiments, the time reversal resonance index measures a similarity of the two or more data samples.

In some embodiments, the deep metric learning measures a similarity between data samples using an embedding neural model.

In some embodiments, the embedding neural model is trained by: collecting, within an environment, data samples surrounding a position of interest and a position outside of a threshold distance from the position of interest; labeling the data samples and their corresponding positions; and train the embedding neural model using the labeled data samples.

In some embodiments, the embedding neural model is trained by: converting, using the embedding neural model, each of the data samples into a latent space; computing a loss using a loss function after each training iteration using a distance function on the latent space; and minimizing the loss after each iteration using back propagation to update weights of the embedding neural model.

In some embodiments, the loss function is a contrastive loss, a triple loss, or a multi similarity loss.

In some embodiments, the embedding neural model is trained by: collecting data samples from within a different environment; and adapting the embedding neural model to obtain a new model for the different environment using the collected data samples from within the different environment.

In some embodiments, the collected data samples from within the different environment include samples from new classes or locations.

One aspect of the present disclosure provides a computer-implemented method for computing a distance metric by a station (STA), in a wireless network. The method comprises obtaining, from one or more access points (APs), channel state information associated with two or more data samples as an input. The method comprises computing a distance metric using at least one of a time reversal resonance index or a deep metric learning using the input, wherein the distance metric is proportional to a true distance between two or more spatial points corresponding to the two or more data samples.

In some embodiments, the method further comprises using magnitude of the channel state information as the input.

In some embodiments, the time reversal resonance index is used to determine positions from which the channel state information originated from.

In some embodiments, the time reversal resonance index measures a similarity of the two or more data samples.

In some embodiments, the deep metric learning measures a similarity between data samples using an embedding neural model.

In some embodiments, the embedding neural model is trained by: collecting, within an environment, data samples surrounding a position of interest and a position outside of a threshold distance from the position of interest; labeling the data samples and their corresponding positions; and training the embedding neural model using the labeled data samples.

In some embodiments, the embedding neural model is trained by: converting, using the embedding neural model, each of the data samples into a latent space; computing a loss using a loss function after each training iteration using a distance function on the latent space; and minimizing the loss after each iteration using back propagation to update weights of the embedding neural model.

In some embodiments, the loss function is a contrastive loss, a triple loss, or a multi similarity loss.

In some embodiments, the embedding neural model is trained by collecting data samples from within a different environment; and adapting the embedding neural model to obtain a new model for the different environment using the collected data samples from within the different environment.

In some embodiments, the collected data samples from within the new environment include samples from new classes or locations.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates channel state information (CSI) in a transmitter (TX) receiver (RX) link in accordance with an embodiment.

FIG. 5 illustrates CSIs from multiple TX-RX links between an STA and an AP in accordance with an embodiment.

FIG. 6 illustrates a Siamese Network in accordance with an embodiment.

FIG. 7 illustrates a Triplet Network in accordance with an embodiment.

FIG. 8 illustrates an example of an embedding model used in Deep Metric Learning in accordance with an embodiment.

FIG. 9 illustrates a flow chart of an example process performed by a STA of computing a distance metric using time reversal resonance index (TRRI) or deep metric learning in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

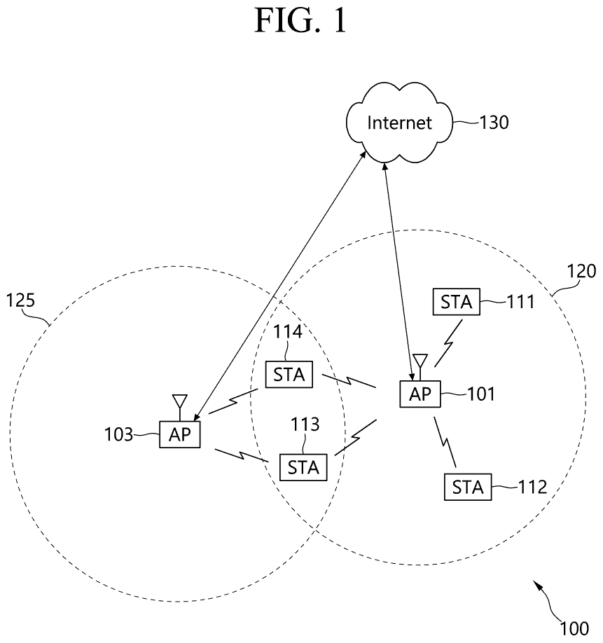

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

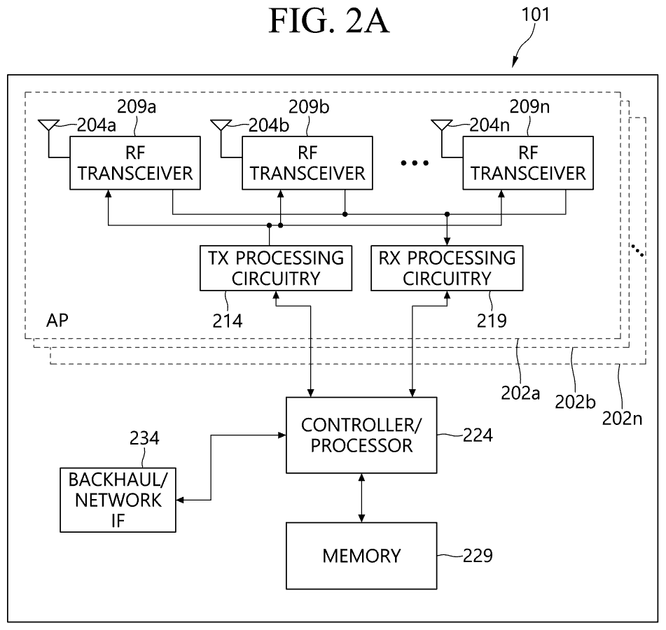

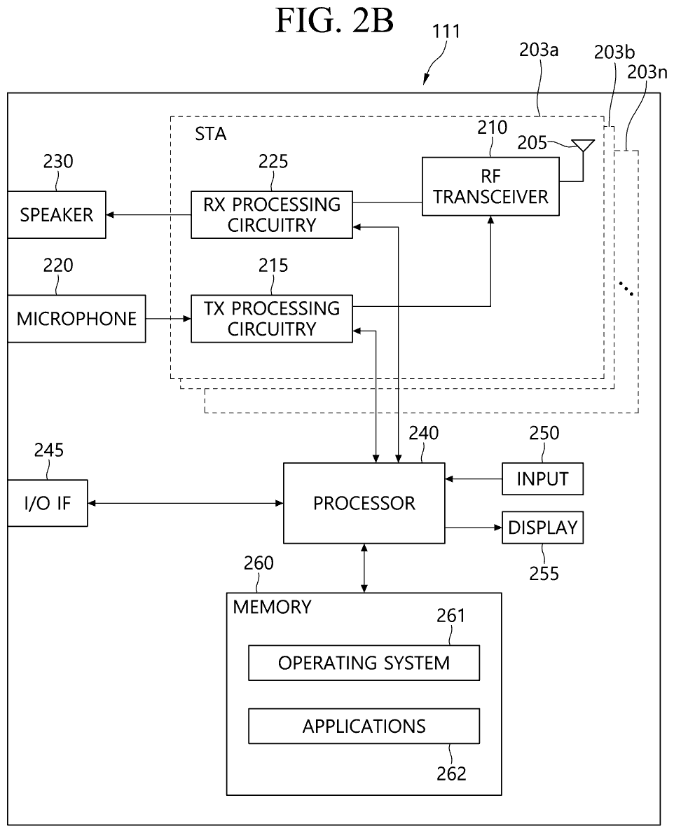

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

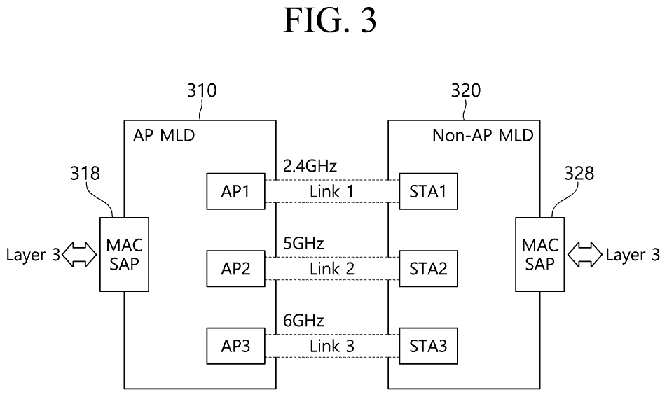

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA I may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

WiFi channel state information (CSI) offers rich information about the propagation link between each station (STA) and surrounding Access Points (APs). Embodiments in accordance with this disclosure may utilize CSI information for localization and physical context applications. In some embodiments, CSI information may be utilized for CSI based fingerprinting applications. In particular, representative CSI samples for each desired location in an indoor environment may be collected as fingerprints and saved into a database. In a zone detection phase, new instantaneous CSI samples collected at the STA are compared with the fingerprints in the database and based on a certain distance metric, the zone of the STA is determined.

In some embodiments, CSI information may be utilized by comparing CSI between two or more devices. This capability can be used in device authentication applications among other applications. In particular, when two stations, STA1 and STA2, are close to each other, their corresponding CSIs to a common AP, CSI1 and CSI2, are expected to be similar to each other. Using a distance metric, the distance between the two CSIs can be calculated and when the distance is smaller than a threshold, the two stations may be determined to be close to each other, so they can be authenticated to share information among them.

In some embodiments, CSI information may be used for CSI based virtual mapping applications and/or navigation applications. In some embodiments, CSI data may be collected when a user is walking with a STA device around an indoor environment. With enough data to represent the whole indoor space, an embedding model can be trained to convert the CSI data into a latent space with dimension of 2 or 3, which me be referred to herein as a “channel chart”. An embedding model may indicate that when two points are close in the original physical space, the embeddings of their CSIs on the channel chart also stay close.

WiFi may be prevalent in most indoor environments. There are existing techniques that may utilize WiFi signal features, including received signal strength indicator (RSSI), channel state information (CSI), and/or round trip time (RTT), among others, within localization applications. However, existing methods based on triangulation or trilateration may not be robust enough in indoor environments due to complex multipath issues. Accordingly, embodiments in accordance with this disclosure may utilize fingerprinting based methods based on WiFi signal features, which may be more robust. Among these features, WiFi Channel State Information (CSI) may offer the richest information, and thus may be used to locate a device in an indoor environment and within a small zone surrounding the location. In particular, CSI data may describe how a signal propagates from a transmitter to a receiver, and may combine the effects of multipaths and/or power decay with distance. This information may also be available across multiple subcarriers. Furthermore, with more recent WiFi generations with increased bandwidth being used, the number of subcarriers may also increase (e.g. IEEE 802.11n-40 MHz, IEEE 802.11ac-80 MHz, IEEE 802.11ax-160 MHz, among others), and the information may be more detailed. Embodiments in accordance with this disclosure may use CSI information in localization and physical context aware applications, including for CSI based fingerprinting applications, in applications that may compare CSI between two or more devices, and CSI-based virtual mapping and navigation applications, among other applications. In some embodiments, for CSI based fingerprinting applications, a process may collect CSI at one spatial point as a fingerprint. Then, during usage, the device's current CSI can be compared with the fingerprint to detect if the device is within a close region surrounding the fingerprint point.

In some embodiments, for comparing CSI between two or more devices, one device may serve as an anchor while the other device (test device), upon detecting closeness to the anchor device (e.g. through RSSI, ultra-wideband (UWB), Bluetooth, WiFi fine time measurement (FTM,) among others), may use the physical context information obtained from WiFi CSI data to authenticate the test device with the anchor device. The properties of CSI data, including its high dimension and highly location specific channel measurements, may significantly improve the security of such context-based authentication applications. In some embodiments, for CSI-based virtual mapping and navigation applications, a process may use the CSI channel chart to generate a virtual map to locate different devices and then navigate to that device following the virtual map.

In some embodiments, a process for localization may include finding a distance metric that can be computed from WiFi features from two points such that the distance metric is small when the two points are close in space, and large when the two points are far from each other. In some embodiments, a distance metric may be based on a Time Reversal Resonance Index (TRRI). In certain embodiments, a distance metric may be based on a deep learning model, which may convert an input feature into an embedding space (typically with smaller dimension), and a distance function such as cosine, L2, L1, among others. In some embodiments, a deep learning model may use a deep metric learning technique. Although many of the embodiments described herein utilized CSI, other WiFi features such as RSSI among others can be used as inputs as appropriate to the requirements of specific applications in accordance with embodiments of the invention.

In some embodiments, at each STA device, there may be RSSI values that measure the power of received signals from one or more APs that exist in the environment. In general, RSSI values may increase as an STA device moves closer to an AP. Thus, RSSI values may provide a representation of the STA's location relative to the APs. To further uniquely determine the location of the STA, it is generally beneficial to have as many RSSI values to the APs as possible. Likewise, a higher number of RSSI values may provide higher dimension input signals, which may improve the security and anti-spoofing capability of a system. In some embodiments, the RSSI values from multiple APs can be formatted as a 1-D vector with RSSI values being concatenated.

Channel State Information (CSI)/Channel Impulse Response (CIR) in accordance with this disclosure is described herein. In some embodiments, CSI may represent the channel properties of a wireless communication link between two devices. CSI may show how a signal propagates from a transmitter to a receiver, including effects from scattering, fading, and/or power reduction with distance.

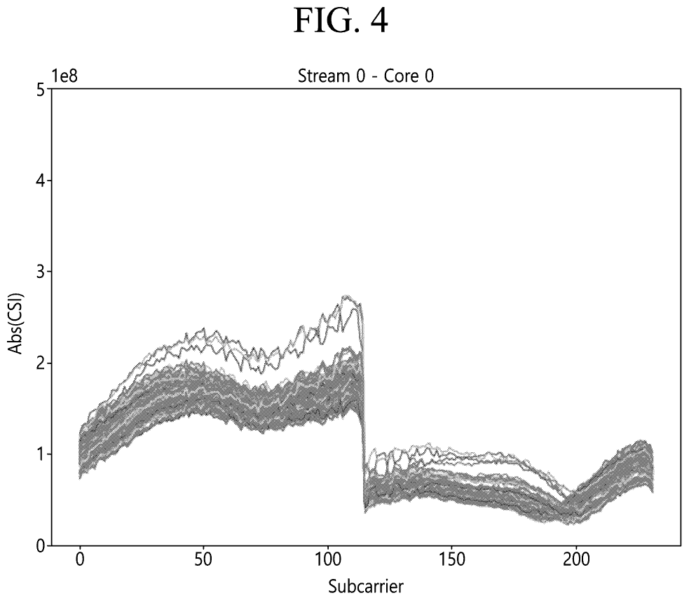

FIG. 4 illustrates a graph of CSI in a TX-RX link with 256 subcarriers (magnitude only) in accordance with an embodiment. In particular, FIG. 4 shows an overlay of multiple CSIs over time from one TX-RX link. Each CSI is a matrix of complex values, one for each subcarrier within the extracted wireless band.

In some embodiments, CSI may be extracted from legacy Long Training Field (L-LTF) and/or generation-specific Long Training Field, such as HT-LTF (IEEE 802.11n), VHT-LTF (IEEE 802.11ac), HE-LTF (IEEE 802.11ax), EHT-LTF (IEEE 802.11be). Typically, the generation-specific LTF provides CSI for individual transmitting and receiving antennas in Multiple Input Multiple Output (MIMO) operations, while L-LTF only provides one CSI for each transmitter-receiver link. Depending on the LTF being used, the size of the input CSI may be different. The following describes some typical cases.

In CSI/CIR from LTF, for each transmitter-receiver link, legacy LTF (L-LTF) provides one CSI, which includes multiple subcarriers, with the number of subcarriers depending on the IEEE 802.11 standards the devices support. The CSI between the STA and surrounding APs can add another dimension of the CSI input matrix. Suppose there are Nₐₚ Access Points, Nₛ subcarriers, the CSI can be represented by a multi-dimensional matrix H∈C^{N}^{ₐₚ}^{×N}^{ₛ}.

When applying Fourier transform on CSI data, its time domain representation, Channel Impulse Response (CIR), can be obtained. The CIR between each pair of transmitting and receiving antennas may include multiple time delay taps. Suppose there are Nₐₚ Access Points, N_{d} delay taps, the CIR can be represented by a multi-dimensional matrix H∈C^{N}^{ₐₚ}^{×N}^{_{d}}.

For CSI/CIR from generation-specific LTF, the CSI between each pair of transmitting and receiving antennas may include multiple subcarriers, with the number of subcarriers depending on the IEEE 802.11 standards the devices support. The CSI between the STA and surrounding APs can add another dimension of the CSI input matrix. Suppose there are Nₐₚ Access Points, Nₜ transmitting antennas, Nᵣ receiving antennas, Nₛ subcarriers, the CSI can be represented by a multi-dimensional matrix H∈C^{N}^{ₐₚ}^{×N}^{ₛ}^{×N}^{ₜ}^{×N}^{ᵣ}.

When applying Fourier transform on CSI data, its time domain representation, Channel Impulse Response (CIR), can be obtained. The CIR between each pair of transmitting and receiving antennas may include multiple time delay taps. Suppose there are Nₐₚ Access Points, Nₜ transmitting antennas, N, receiving antennas, N_{d} delay taps, the CIR can be represented by a multi-dimensional matrix H∈C^{N}^{ₐₚ}^{×N}^{_{d}}^{×N}^{ₜ}^{×N}^{ᵣ}

For input shaping methods for raw CSI/CIR, both CSI and CIR representation can be used as high dimensional input matrix to the distance metric calculation. Different variations of the formatting can be utilized, including but not limited to the following.

Some embodiments may use only magnitude (real value) of the CSI/CIR as input.

Some embodiments may use both magnitude (real value) and phase (real value) of the CSI/CIR as input. The magnitude and phase may be stacked on top of each other in one dimension, for example, the CSI matrix can be reformatted from the size H∈C^{N}^{ₐₚ}^{×N}^{ₛ}^{×N}^{ₜ}^{×N}^{ᵣ} to the size H*∈R²^{_{Nap}}^{×N}^{ₛ}^{×N}^{ₜ}^{×N}^{ᵣ}

Some embodiments may use both magnitude (real value) and phase (real value) of the CSI/CIR as input. The magnitude and phase may be put on different channels, for example, the CSI matrix can be reformatted from the size H∈C^{N}^{ₐₚ}^{×N}^{ₛ}^{×N}^{ₜ}^{×N}^{ᵣ} to the size H*∈R²^{_{Nap}}^{×N}^{ₛ}^{×N}^{ₜ}^{×N}^{ᵣ}

In some embodiments, the CSI/CIR can be either unnormalized, normalized, or normalized and then scaled by associated RSSI values.

In some embodiments, the ratio between CSI in a pair with common TX or common RX can be used, since it can be more stable than individual CSI, due to common CSI offsets are eliminated by taking CSI ratio.

Embodiments in accordance with this disclosure may use one or more of the following different matrix reshaping methods for obtaining an input matrix for distance metric calculation.

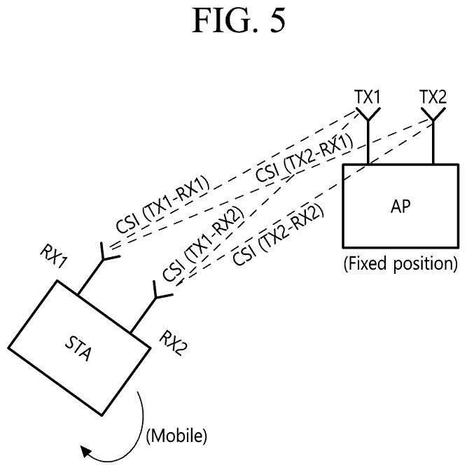

FIG. 5 illustrates CSIs from multiple TX-RX links between an STA and an AP in accordance with an embodiment. As described in the examples that follow, the mobile device (STA) may act as a receiver with 2 receivers (RXs) and the Access Point (at a fixed position) may act as a transmitter with 2 transmitters (TXs). Each TX-RX link may provide one CSI matrix, and thus, may provide 4 CSI matrices in total. As illustrated in FIG. 5, the 4 CSI matrices include CSI (TX1-RX1), CSI (TX2-RX1), CSI (TX1-RX2), and CSI (TX2-RX2).

In some embodiments, in a first method 1, the magnitudes of CSIs may be stacked on top of each other, making a matrix of shape (4, Nₛ, 1), as follows:

MagCSI(TX0-RX0)
MagCSI(TX1-RX0)
MagCSI(TX0-RX1)
MagCSI(TX0-RX0)

In some embodiments, in a second method 2, the magnitude of each CSI may be normalized then they are stacked on top of each other, making a matrix of shape (4, Nₛ, 1), as follows:

NormMagCSI(TX0-RX0)
NormMagCSI(TX1-RX0)
NormMagCSI(TX0-RX1)
NormMagCSI(TX0-RX0)

In some embodiments, in a third method 3, the magnitude of each CSI may be normalized, then scaled by the RSSI value of the corresponding link. After that, they are stacked on top of each other, making a matrix of shape (4, Nₛ, 1), as follows:

ScaledNormMagCSI(TX0-RX0)
ScaledNormMagCSI(TX1-RX0)
ScaledNormMagCSI(TX0-RX1)
ScaledNormMagCSI(TX0-RX0)

In some embodiments, in a fourth method 4, first a CSI ratio between each CSI pair of the same RX may be calculated. Then for each CSI ratio, the real and imaginary parts are separated into 2 channels. The outcome matrix is of shape (2, Nₛ, 2): CSI_ratio[RX0]=CSI[TX0-RX0]/CSI [TX1-RX0]; CSI_ratio[RX1]=CSI[TX0-RX1]/CSI[TX1-RX1], as follows:

| | |
|---|---|
| Chan2 | Imag(CSI_ratio[RX0]) |
| | Imag(CSI_ratio[RX1]) |
| Chan1 | Real(CSI_ratio[RX0]) |
| | Real(CSI_ratio[RX1]) |

In some embodiments, in a fifth method 5, a first CSI ratio between each CSI pair of the same TX is calculated. Then for each CSI ratio, the real and imaginary parts are separated into 2 channels. The outcome matrix is of shape (2, Nₛ, 2): CSI_ratio[TX0]=CSI[TX0-RX0]/CSI [TX0-RX1]; CSI_ratio[TX1]=CSI[TX1-RX0]/CSI[TX1-RX1], as follows:

| | |
|---|---|
| Chan2 | Imag(CSI_ratio[TX0]) |
| | Imag(CSI_ratio[TX1]) |
| Chan1 | Real(CSI_ratio[TX0]) |
| | Real(CSI_ratio[TX1]) |

In some embodiments, in a sixth method 6, first a CSI ratio between each CSI pair of the same RX may be calculated. Then for each CSI ratio, the magnitude, the sine and the cosine parts are separated into 3 channels. The outcome matrix is of shape (2, Nₛ, 3): CSI_ratio[RX0]=CSI[TX0-RX0]/CSI[TX1-RX0]; CSI_ratio[RX1]=CSI[TX0-RX1]/CSI[TX1-RX1], as follows:

| | |
|---|---|
| Chan3 | Cosine(CSI_ratio[RX0]) |
| | Cosine(CSI_ratio[RX1]) |
| Chan2 | Sine(CSI_ratio[RX0]) |
| | Sine(CSI_ratio[RX1]) |
| Chan1 | MagCSI(TX0-RX0) |
| | MagCSI(TX0-RX1) |

Distance metric in accordance with this disclosure is described herein. In some embodiments, a distance metric that can be calculated directly between two CSI samples is a Time Reversal Resonating Index (TRRI). The TRRI γ(H₁, H₂) between two CIRs H₁=[h₁ [0], h₁ [1], . . . h₁ [L−1]] and H₂=[h₂ [0], h₂ [1], . . . h₂ [L−1]] can be calculated as set forth in the following equation (1):

$$γ ( {H}_{1} , {H}_{2} ) = \frac{{max}_{i} {\vert {H}_{1} * {G}_{2} [ i ] \vert}^{2}}{( {\sum }_{i = 0}^{L - 1} {\vert {h}_{1} [ i ] \vert}^{2} ) ( {\sum }_{j = 0}^{L - 1} {\vert {g}_{2} [ j ] \vert}^{2} )} \qquad ( 1 )$$

where G₂=[g₂[0], g₂[1], . . . , g₂[L−1] is defined as the time reversed and conjugated version of H₂ as follows in equation (2):

$${g}_{2} [ k ] = {h}_{2}^{*} [ L - 1 - k ] , k = 0 , 1 , … , L - 1 \qquad ( 2 )$$

In some embodiments, the TRRI value is within [0, 1] range where a higher value means the two contributing CSIs are more similar to each other. The expectation may be that when the two CSIs are from two positions very close in space, they would be similar in shape, thus the output TRRI value would be high.

In some embodiments, the TRRI formula may be used between two CSIs from two individual transmitter-receiver pairs. In some embodiments, with additional pairs coming from more APs or more antennas in a MIMO setup, the TRRI values from all the pairs can be averaged to get the final TRRI score. This TRRI score may then be compared with a predefined threshold to determine whether the two CSIs are coming from two positions close in space.

Deep Metric Learning in accordance with this disclosure is described herein. In some embodiments, the distance metric may be learned through a group of techniques belonging to Deep Metric Learning, which aims to measure the similarity between data samples. In a formal definition, for a set of data points X and their corresponding labels Y (a discrete finite set), the goal is to train an embedding neural model (which may be referred to herein as a feature extractor) f_{θ}(.): X→ [symbol] ⁿ (where θ are learned weights) together with a distance [symbol] : [symbol] ⁿ→ [symbol] , so that for two data samples x₁, x₂∈X together with their labels y₁, y₂∈Y such that:

$$\begin{matrix}( {f}_{θ} ( {x}_{1} ) , {f}_{θ} ( {x}_{2} ) ) is small if {y}_{1} = {y}_{2} \\ ( {f}_{θ} ( {x}_{1} ) , {f}_{θ} ( {x}_{2} ) ) is small if {y}_{1} \neq {y}_{2}\end{matrix}$$

In some embodiments, first, the WiFi data (which can be RSSI, CSI, or CIR, among other data) surrounding each position of interest (in-zone) as well as other positions far from that position (out-zone) should be collected. After data collection, WiFi data samples are labeled with their corresponding zones. The input to the neural network models can be obtained as described herein (including matrixes from RSSI values, CSI values, CIR values, or some composite matrix among other values). Then all the data samples (together with their labels) can be used to train a Deep Metric Learning neural network model.

In some embodiments, in a Deep Metric Learning neural network model, there may be an embedding model, or feature extractor, to convert each input sample into a latent space. Together with a predefined distance function on the latent space (such as L1 distance, L2 distance, cosine distance, among others), the loss after each training iteration can be calculated. Different loss functions can be used, such as Contrastive Loss, Triplet Loss, Multi Similarity Loss, among others. In some embodiments, the model may try to minimize the loss after each iteration by performing back propagation operation to update the weights of the network. In some embodiments, the two most common loss functions are Contrastive Loss and Triplet Loss, as described herein.

Contrastive Loss in accordance with this disclosure is described herein. In some embodiments, Contrastive Loss may be used in Siamese networks.

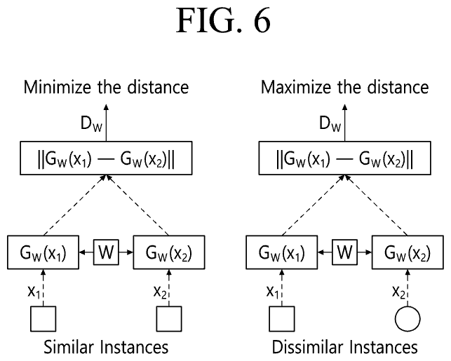

FIG. 6 illustrates a Siamese network in accordance with an embodiment. A Siamese network may have two inputs. In particular, FIG. 6 illustrates calculations with similar instances of inputs x₁ and x₂ that minimize the distance and dissimilar instances where inputs x₁ and x₂ maximize the distance. In particular, x/is provided to G_{w}(X₁) and x₂ is provided to G_{w}(X₂). These values are provided to the equation: ∥G_{W}(X₁)−G_{W}(X₂) ∥ to calculate the distance D_{W}. In some embodiments, after both inputs are embedded into the latent space, their distance D_{W} is calculated. Also, based on their corresponding labels, a value Y is determined: Y=0 if the labels are similar and Y=1 if the labels are different. Then the contrastive loss can be calculated based on equation (3):

$${L}_{contrastive} = \frac{( 1 - Y ) {( {D}_{W} )}^{2}}{2} + \frac{{Y ( max ( 0 , m - {D}_{W} ) )}^{2}}{2} \qquad ( 3 )$$

Triplet Loss in accordance with this disclosure is described herein. In some embodiments, Triplet Loss may be used in Triplet Networks.

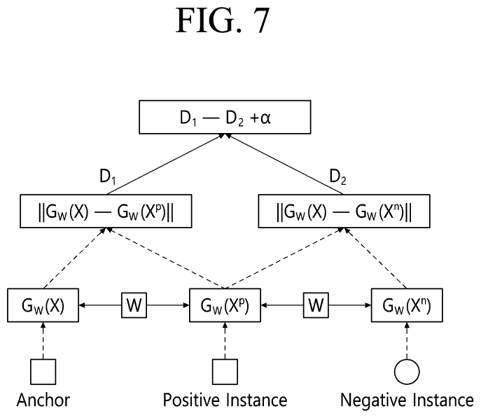

FIG. 7 illustrates a Triplet Network in accordance with an embodiment. As illustrated, in some embodiment, a Triplet network has three inputs (anchor, positive and negative). The anchor and positive samples may be ones with the same label, while the negative sample may be one with a different label from the anchor sample. As illustrated, anchor is provided to G_{W}(X), positive instance is provided to G_{W}(X^{p}) and negative instance is provided to G_{w}(Xⁿ). Upon embedding the inputs into the latent space, the triplet loss aims to push the embedding point of the negative sample further away from the embedding point of the positive sample with at least a margin a, with respect to the embedding point of anchor sample, as provided by equation (4):

$${L}_{triple} = max ( 0 , {‖ {G}_{W} ( X ) - {G}_{W} ( {X}^{p} ) ‖}_{2} - {‖ {G}_{W} ( X ) - {G}_{W} ( {X}^{n} ) ‖}_{2} + α ) \qquad ( 4 )$$

In some embodiments, upon training, the embedding model can be used to do feature extraction (embedding) on new input samples. The embedding of each input sample may then be compared with previous embeddings with known labels to determine whether the STA is close to a position of interest. In some embodiments, different techniques can be used, such as Nearest Neighbor, k-Nearest Neighbors, Clustering, among others.

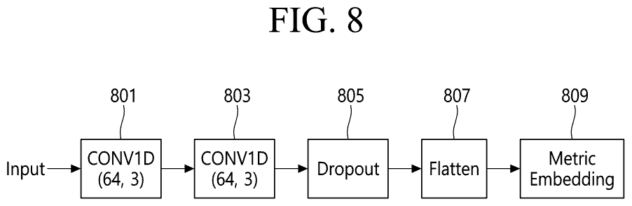

FIG. 8 illustrates an example of an embedding model used in Deep Metric Learning in accordance with an embodiment. In some embodiments, the following embedding model can be used. The input matrix may be fed into two layers of Convolution 1D of size (64, 3) 801 and 803, followed by Dropout layer 805 and Flatten layer 807 layer to obtain the Metric Embedding 809 representation.

In some embodiments, Deep Metric Learning may be able to learn an embedding model that maps new CSI samples into points on a latent space that are close to their corresponding close physical fingerprints, given the new CSI samples are from the same environment. However, it may be often the case that the new CSI samples are from a different environment from the one where the embedding model was trained. For example, a generic embedding model can be trained for a smart phone model, but each user of this model may have their own zones within the house. In some embodiments, in order to improve the performance of Deep Metric Learning approach in the new environment, an adaptation using Few-shot Learning can be applied. In some embodiments, a meta-learning training procedure may be utilized to learn a generic Deep Metric Learning model that can quickly adapt to a new task (e.g., classification on new classes) using only a few new examples. In some embodiments, such new samples can be collected either actively (e.g. user collects a few samples from each desired locations or classes) or in the background (e.g. user goes about their life while device collects samples when new context is detected).

In some embodiments, the extension of Deep Metric Learning to Few-shot Learning setup should maintain the distance metrics using Metric Learning while adapting the metric space to unseen classes. To do so, a generic framework in accordance with some embodiments may be as follows, and may include a training phase and a adaption phase.

In some embodiments, during the training phase, the training dataset may be assumed to have CSI samples from a large number of classes or locations (denote Vₜᵣₐᵢₙ as the classes in the training dataset). In the training phase, instead of using a large number of samples from all the available as in the traditional Deep Metric Learning, the learning may be set up to be similar to when the model is used in the test. In particular, for each batch of training samples, C classes in Vₜᵣₐᵢₙ are randomly sampled. Then K samples for each of these C classes are randomly chosen, making K*C samples per batch. Each training epoch may include B such batches. The training may still use the same training loss as in the Deep Metric Learning. By shuffling the classes that the model sees in each batch, the training may help improve the generalizability of the model when being presented with only a few samples of new classes.

In some embodiments, during the adaptation phase (to the new environment), after the training phase with samples from a large number of classes or locations, the trained model may be adapted in the new environment using a small number of samples from new classes or locations. Let C be the number of new classes. First, K samples for each of the C classes are collected to build a support set. The K support samples may be used to do adaptation for the previously trained model to obtain a new model. To do adaptation, a small number of gradient update steps using the support samples may be performed.

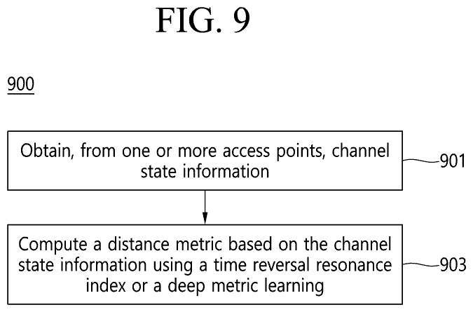

FIG. 9 illustrates a flow chart of an example process performed by a STA of computing a distance metric using TRRI or deep metric learning in accordance with an embodiment. Although one or more operations are described or shown in particular sequential order, in other embodiments the operations may be rearranged in a different order, which may include performance of multiple operations in at least partially overlapping time periods. The flowchart depicted in FIG. 9 illustrates operations performed in an STA, such as the STA illustrated in FIG. 3.

The process 900, in operation 901, the STA obtains from one or more APS, channel state information (CSI). In some embodiments, CSI may represent the channel properties of a wireless communication link between two devices. CSI may show how a signal propagates from a transmitter to a receiver, including effects from scattering, fading, and/or power reduction with distance.

In operation 903, the STA computes a distance metric based on the channel state information. In some embodiments, a process for localization may include finding a distance metric that can be computed from WiFi features from two points such that the distance metric is small when the two points are close in space, and large when the two points are far from each other. In some embodiments, a distance metric may be based on a Time Reversal Resonance Index (TRRI). In certain embodiments, a distance metric may be based on a deep learning model, which may convert an input feature into an embedding space (typically with smaller dimension), and a distance function such as cosine, L2, L1, among others. In some embodiments, a deep learning model may use a deep metric learning technique. Although many of the embodiments described herein utilized CSI, other WiFi features such as RSSI among others can be used as inputs as appropriate to the requirements of specific applications in accordance with embodiments of the invention.

Embodiments in accordance with this disclosure may use WiFi CSI information for localization and physical context applications, which provides improved or more robust localization within an indoor environment.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to:
obtain, from one or more access points (APs), channel state information associated with two or more data samples as an input; and
compute a distance metric using at least one of a time reversal resonance index or a deep metric learning using the input, wherein the distance metric is proportional to a true distance between two or more spatial points corresponding to the two or more data samples.

2. The STA of claim 1, wherein the processor is further configured to use magnitude of the channel state information as the input.

3. The STA of claim 1, wherein the time reversal resonance index is used to determine positions from which the channel state information originated from.

4. The STA of claim 1, wherein the time reversal resonance index measures a similarity of the two or more data samples.

5. The STA of claim 1, wherein the deep metric learning measures a similarity between data samples using an embedding neural model.

6. The STA of claim 5, wherein the embedding neural model is trained by:
collecting, within an environment, data samples surrounding a position of interest and a position outside of a threshold distance from the position of interest;
labeling the data samples and their corresponding positions; and
training the embedding neural model using the labeled data samples.

7. The STA of claim 6, wherein the embedding neural model is trained by:
converting, using the embedding neural model, each of the data samples into a latent space;
computing a loss using a loss function after each training iteration using a distance function on the latent space; and
minimizing the loss after each iteration using back propagation to update weights of the embedding neural model.

8. The STA of claim 7, wherein the loss function is a contrastive loss, a triple loss, or a multi similarity loss.

9. The STA of claim 7, wherein the embedding neural model is trained by:
collecting data samples from within a different environment; and
adapting the embedding neural model to obtain a new model for the different environment using the collected data samples from within the different environment.

10. The STA of claim 9, wherein the collected data samples from within the different environment include samples from new classes or locations.

11. A computer-implemented method for computing a distance metric by a station (STA), in a wireless network, comprising:
obtaining, from one or more access points (APs), channel state information associated with two or more data samples as an input; and
computing a distance metric using at least one of a time reversal resonance index or a deep metric learning using the input, wherein the distance metric is proportional to a true distance between two or more spatial points corresponding to the two or more data samples.

12. The computer-implemented method of claim 11, further comprising using magnitude of the channel state information as the input.

13. The computer-implemented method of claim 11, wherein the time reversal resonance index is used to determine positions from which the channel state information originated from.

14. The computer-implemented method of claim 11, wherein the time reversal resonance index measures a similarity of the two or more data samples.

15. The computer-implemented method of claim 11, wherein the deep metric learning measures a similarity between data samples using an embedding neural model.

16. The computer-implemented method of claim 15, wherein the embedding neural model is trained by:
collecting, within an environment, data samples surrounding a position of interest and a position outside of a threshold distance from the position of interest;
labeling the data samples and their corresponding positions; and
training the embedding neural model using the labeled data samples.

17. The computer-implemented method of claim 16, wherein the embedding neural model is trained by:
converting, using the embedding neural model, each of the data samples into a latent space;
computing a loss using a loss function after each training iteration using a distance function on the latent space; and
minimizing the loss after each iteration using back propagation to update weights of the embedding neural model.

18. The computer-implemented method of claim 17, wherein the loss function is a contrastive loss, a triple loss, or a multi similarity loss.

19. The computer-implemented method of claim 17, wherein the embedding neural model is trained by:
collecting data samples from within a different environment; and
adapting the embedding neural model to obtain a new model for the different environment using the collected data samples from within the different environment.

20. The computer-implemented method of claim 19, wherein the collected data samples from within the new environment include samples from new classes or locations.
